(19) United States
(12) Patent Application Publication
(10) Pub. No.: US 2014/0300828 A1
(43) Pub. Date: Oct. 9, 2014

(54) SYSTEM FOR AUDIO SIGNAL REBROADCASTING FROM A T.V. SET

(71) Applicant: Collin Maximillian Kowalchuk, Arades (PT)

(72) Inventor: Collin Maximillian Kowalchuk, Arades (PT)

(21) Appl. No.: 13/856,841

(22) Filed: Apr. 4, 2013

(51) Int. Cl. H04H 20/86; H04N 5/60

(52) U.S. Cl. CPC H04H 20/86; H04N 5/607
USPC 348/738

(57) ABSTRACT

A remote audio rebroadcasting and monitoring system has been disclosed which consists of a transmitter device and one or more remote wireless broadcast receiver devices. An audio input signal is extracted from an external universal output port integrated with a T.V. set and propagated into the transmitter device through an audio transfer linkage. Broadcast proceeds over a set programmed radio wave channel compliant with wireless transfer and reception of the audio signals described. The broadcast receiver device senses the channel at a remote location, removed from said transmitter device. Two additional auxiliary devices that comprise a transmitter to broadcast receiver interaction provide a means for broadcasting an overriding vocal audio signal globally via the transmitter to broadcast receiver device pathway with the coincident interruption of the audio input signal.

### CROSS-REFERENCE TO RELATED APPLICATIONS

No related applications have been filed by the aforementioned author.

### US PATENT DOCUMENTS

| | | |
|---|---|---|
| 3,427,543 | February 1969 | Kenichi |
| 3,259,689 | July 1966 | Sienkiewicz |
| 4,021,737 | May 1977 | Trask |
| 5,243,415 | September 1993 | Vance |
| 5,418,577 | May 1995 | Bagley |
| 5,628,056 | May 1997 | Grysiewicz |

### BACKGROUND OF THE INVENTION

1. Field

This invention generally relates to an audio rebroadcasting system, specifically to a transmitter device that broadcasts an audio signal extracted from a T.V. set which can be sensed by one or more remote wireless broadcast receiver devices.

2. Prior Art

Previously, remote audio reception from a T.V. set with inaudible of muted sound has been limited to hard wired connections or AM/FM radio wave rebroadcasting devices. Hardwiring requires the stringing of cables which can lead to deterioration of the audio signal and constitute a safety hazard. The second type, AM/FM radio wave rebroadcasting devices, such as those proposed by Sienkiewicz (1969), Kenichi (1969), Vance (1993), Bagley (1995) and Grysiewicz (1997), have a very limited useful range; a necessity that results from compliancy with the legal implications of non-professional broadcasting.

The prior art describes a diverse means of interconnection with said T.V. set: the devices put froth by Trask (1997) and Grysiewicz (1997) are interconnected wirelessly either through placement of a combination receiver-transmitter device in close proximity to an audible speaker or sensing the broadcasted channel itself, respectively; Kenichi (1969), Vance (1993), Bagley (1995) and Sienkiewicz (1996) alternatively utilized varied hardwired architectures. A universal method for audio signal extraction is required from the plurality of audio input devices capable of generating an audio input signal which include a T.V. set, cable, satellite and receiver boxes.

A transmitter device of the invention described herein broadcasts said audio input signal. A universal connection with the audio input device occurs through a plug and port interaction. A linkage provides a physical interconnection between said transmitter and audio input devices, which overcomes a significant shortcoming endured by the prior art. Additionally no specialized circuit is required to select the audio component exclusive of the video as utilized in the case of Sienkiewicz (1996). Alternatively, in the case of Vance (1993) no specific audio signal selection was performed. Bagley (1995) utilized a so called branch connector that not only greatly increases the complexity of connectivity with an obvious incompatibility with the plethora of types and current interconnections employed, but may also induce unwanted or harmful interference. The channel over which broadcast proceeds for the invention described herein can be remotely switched to one of many set programmed channels, a property not described in the prior art. Comprising said channel is a narrowband or a wide bandwidth radio wave frequency modulated by an analogue or digital format. Through utilization of well known processes and technology many channels can be specifically described. The manner itself, by which these channels are classified provides for a low level security measure, thus minimizing any external interference; a property not described by the prior art. A broadcast receiver device senses, processes and outputs the broadcasted set programmed channel to an aural listening device. The broadcast receiver device contains a user controlled means for switching in between said channels. Implementation of this setup provides for a greater level of security than the AM/FM radio wave format employed by the prior art. Additionally a means for input of said channels into the broadcast receiver device is provided; an advancement beyond the utilization of a simple radio wave tuner device as previously described. Both monoaural and stereo format transmitter and broadcast receiver devices are described. Additionally an override broadcast receiver add-on auxiliary device and an override transmitter auxiliary device are described and allow for interruption of the audio input signal and broadcast of a user's vocal audio signal; a feature of this invention not attributed to any of the aforementioned prior art. Said overriding auxiliary devices participate in an imposed single layer authentication process which decreases the probability of external interference being broadcasted globally via the transmitter to broadcast receiver device pathway. The auxiliary devices can be utilized in conjunction with both of the monoaural and stereo format devices.

All of the devices described herein comply with FCC rule 15 in that harmful interference is not generated and any received interference is accepted even if said acceptance has an adverse affect for device operation.

### SUMMARY

In accordance with the preferred embodiment a transmitter device is connected via an audio transfer linkage to an audio input device via an output port. An audio input signal is generated by a T.V. set, cable, satellite or a receiver box. The audio transfer linkage consists of plugs at each terminus interconnected by a cord. The audio input device terminus plug is a universal connector including the plurality of a SCART, RCA, headphone, 3.5 mm, optical or a HDMI type. At the transmitter device terminus another plug and port interconnection, not necessarily of the same type, allows for propagation of an audio signal generated by the audio input device into said transmitter device. Said transmitter device modulates the audio signal to a set programmed channel and broadcasts.

A broadcast receiver device is described that can remotely sense and process said set programmed channel being broadcasted and outputs an audio signal to an aural listening device.

An override broadcast receiver add-on auxiliary device is described that interrupts said audio transfer linkage and connects with said transmitter device through an auxiliary audio transfer linkage. This device allows for the selective propagation of either the audio input signal or a remotely sensed vocal audio signal into said transmitter device. Said vocal audio signal and a companion activation signal are broadcasted from an override transmitter auxiliary device over similarly defined set programmed channels.

An operational combination of the components including the audio transfer linkage, transmitter device, broadcast receiver device and aural listening device are described; multiples of these individual components can function concurrently by utilization of distinct channels. The auxiliary devices including said override broadcast receiver add-on and override transmitter are augmentations to said operational combination.

The above brief description sets the more important features of the present invention forth rather broadly. A more detailed description thereof follows and may be better understood as to specific contributions to the art. Additional features described hereinafter will contribute subject matter that appends the claims.

Before explaining the preferred embodiment of the invention in detail, it will be understood that the invention is not limited in its application to the details of the construction and the arrangements of the components set forth in the following description or illustrated in the drawings. The invention can have other embodiments and may be carried about in other ways. The terminology and phraseology employed herein is set forth for the purpose of description and is not intended nor should be regarded as limiting.

Skilled individuals will appreciate that this disclosure can be utilized for the details herein for designing or carrying out other structures; methods or systems for purposes of the present invention and therefore the claims are to be regarded as including such equivalent constructions insofar as they do not depart from the spirit of the present invention.

It is therefore an object of this invention, taking into account the above, to provide a description of the audio transfer linkage, transmitter and broadcast receiver devices and the auxiliary audio transfer linkage, override broadcast receiver add-on and override transmitter auxiliary devices.

Another object of the invention is that the devices can operate in monoaural or stereo format and the auxiliary devices are compliant with both formats.

Still another object of the invention is that the described devices can be manufactured and marketed publicly.

Yet another object of the invention allows for the transmitter device to broadcast over a ‘line of sight’ distance.

Yet another object of the invention provides for a universal connection of the transmitter device to the audio input device.

Another object of the invention is that the transmitter device can be modulated to broadcast over one of many set programmed channel descriptions or over two interrelated set programmed channel descriptions for the monoaural and stereo devices, respectively.

Yet another object of the invention allows for the receiver device to input and receive said set programmed channel description(s).

Another object of the invention is that the broadcast from a single transmitter device can be sensed by multiple broadcast receiver devices.

Another object of the invention allows for a separate manner in the way which channel classification is performed as compared to the prior art.

Another object of the invention allows for the set programmed channel descriptions to be input into and stored in a memory function built into the broadcast receiver device.

Yet another object of the invention is that the broadcast receiver devices allows for an output audio signal to be user assessable via an aural listening device.

Another object of the invention provides for a volume control to be built into the broadcast receiver device.

A further object of the invention provides for integrated channel switching functions to be built into each of the transmitter and broadcast receiver devices and the override broadcast receiver add-on and override transmitter auxiliary devices to facilitate channel modification.

Another object of the invention allows the override broadcast receiver add-on auxiliary device to be preferentially associated with said transmitter device.

Another object of the invention allows the override broadcast receiver add-on auxiliary device to gate in between and propagate either a vocal audio signal or the audio input signal into the transmitter device.

Another object of the invention allows the override transmitter auxiliary device to broadcast a vocal audio and an activation signal simultaneously.

Another object of the invention requires that both of the channels containing the vocal audio and the activation signals be concurrently sensed to induce gating.

Still another object of the invention allows for the override add-on auxiliary device to minimize global interference being broadcasted via the transmitter to broadcast receiver device pathway.

Another object of the invention allows the antennae associated with the stereo transmitter and the override transmitter auxiliary device to broadcast two channels simultaneously.

Still another object of the invention allows the antennae associated with the stereo broadcast receiver device and the override broadcast receiver add-on auxiliary device to sense multiple signals simultaneously.

Another object of the invention allows for the remote settings of inaccessibly installed devices to be modified via utilization of a remote control device.

Yet another object of the invention allows for the override broadcast receiver add-on auxiliary device to sense, accept, demodulate and decode the broadcasted channel containing the user's vocal audio signal in the presence or absence of the sensed activation signal.

Still another object of the invention is that incorporation of a display into each of the described devices and auxiliary devices allows for relevant information to be shown.

Another object of the invention is that all of the devices described herein are compliant with FCC rule 15.

Finally another object of the invention provides for each device and auxiliary device to be freely utilized with all known television standards including NTSC (United States of America and Japan's standard), PAL used in Europe except France that utilizes the SECAM format.

These together with still other objects of the invention and the various other features of novelty that characterize the invention are further described in the annexed claims comprised as part of this disclosure.

### DRAWINGS

### Reference Numerals

[1] audio input device
[2] audio input signal
[3] T.V. set output port
[4] audio transfer linkage
[5] universal audio connector plug
[6] cord
[7] audio connector plug (second)
[8] transmitter input port
[9] housing
[10] transmitter device
[11] monoaural transmitting antenna
[12] stereo transmitting antenna
[13] a means for electrification
[14] display
[15] infrared window
[16] broadcast receiver device
[17] receiver housing
[18] monoaural receiving antenna
[19] stereo receiving antenna
[20] aural listening device
[21] means for interconnection of the aural listening device
[22] means for anchorage
[23] display
[24] a means for modifying the device's settings
[25] remote control housing
[26] infrared diode
[27] power switch of the transmitter device
[28] channel switching function of the transmitter device
[29] power switch of the broadcast receiver add-on auxiliary device
[30] channel switching function of the override broadcast receiver add-on auxiliary device
[31] channel switching function of the override broadcast receiver add-on auxiliary device
[32] control switching function for the transmitter device
[33] control switching function of the override broadcast receiver add-on auxiliary device
[34] means for electrification
[35] display
[36] amplifier and filter combination
[37] microprocessor
[38] monoaural audio signal
[39] channel changer function
[40] frequency mixing function
[41] frequency oscillator
[42] channel containing the monoaural audio signal
[43] amplifier
[44] channel switching function
[45] power switch
[46] left audio signal
[47] right audio signal
[48] stereo amplifier and splitter
[49] left audio signal channel changer function
[50] right audio signal channel changer function
[51] microprocessor
[52] left audio signal frequency mixing function
[53] right audio signal frequency mixing function
[54] left audio signal frequency oscillator
[55] right audio signal frequency oscillator
[56] channel containing the left audio signal
[57] channel containing the right audio signal
[58] amplifier and filter combination
[59] amplifier and filter combination
[60] channel switching function
[61] means for electrification
[62] integrated port
[63] compatible plug
[64] cord
[65] transformer
[66] power plug
[67] microprocessor
[68] channel changer function
[69] frequency mixing function
[70] frequency resonator
[71] amplifier
[72] amplifier
[73] monoaural aural listening device
[74] volume control function
[75] means to input broadcasting channels
[76] channel memory function
[77] channel switching function
[78] power switch
[79] microprocessor
[80] channel changer function
[81] channel changer function
[82] frequency mixing function
[83] frequency mixing function
[84] frequency resonator
[85] frequency resonator
[86] amplifier
[87] amplifier
[88] amplifier
[89] amplifier
[90] stereo aural listening device
[91] volume control function
[92] means for inputting broadcasting channels
[93] channel memory function
[94] channel switching function
[95] override transmitter device housing
[96] transmitting antenna
[97] means for electrification
[98] microphone device
[99] plug
[100] port
[101] cord
[102] housing
[103] microphone
[104] activate transmission switch
[105] power switch
[106] display
[107] means for modifying the device's settings
[108] housing
[109] means for electrification
[110] port
[111] plug
[112] cord
[113] transformer
[114] power plug
[115] vocal audio signal
[116] amplifier
[117] activation signal
[118] microprocessor
[119] channel changer function
[120] frequency mixing function
[121] frequency oscillator
[122] channel containing the vocal audio signal
[123] channel changer function
[124] frequency mixing function
[125] frequency oscillator
[126] channel containing the activation signal
[127] amplifier and filter
[128] channel switching function
[129] channel switching function
[130] means for electrification
[131] input port
[132] housing
[133] output port
[134] auxiliary linkage
[135] cord
[136] terminal plug
[137] terminal plug
[138] antenna
[139] display
[140] infrared window
[141] microprocessor
[142] channel changer function
[143] channel changer function
[144] frequency mixing functions
[145] frequency mixing functions
[146] frequency resonator
[147] frequency resonator
[148] amplifier
[149] gating function
[150] gated pathway with propagation of the audio input signal
[151] gated pathway with maintained propagation of the audio input signal
[152] gated pathway with propagation of the vocal audio signal
[153] amplifier
[154] power switch
[155] channel switching function
[156] channel switching function

### BRIEF DESCRIPTION OF THE FIGURES

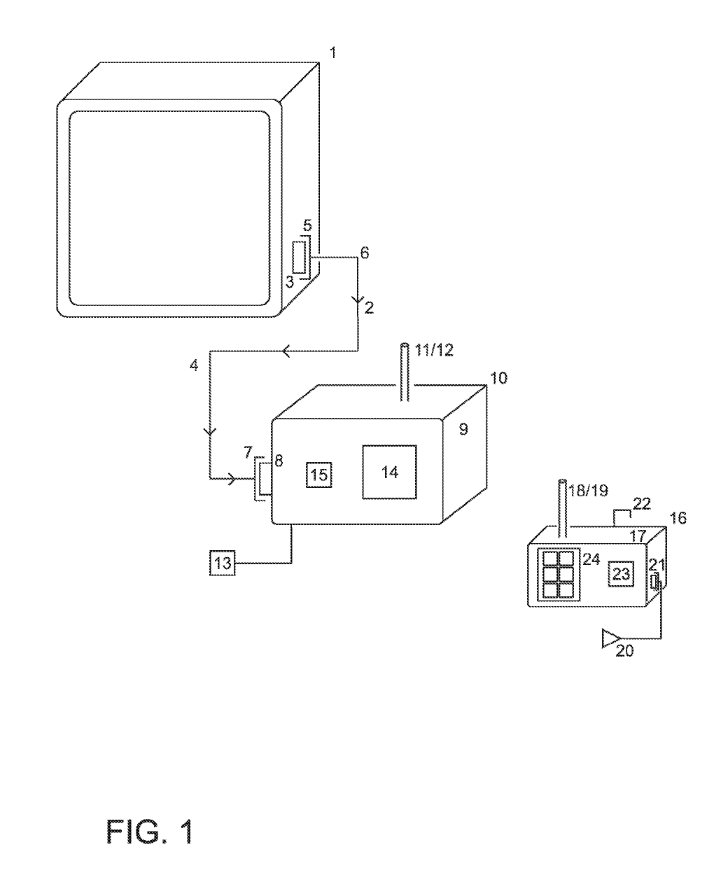

FIG. 1 is a perspective view of the components comprising the preferred embodiment of the invention.

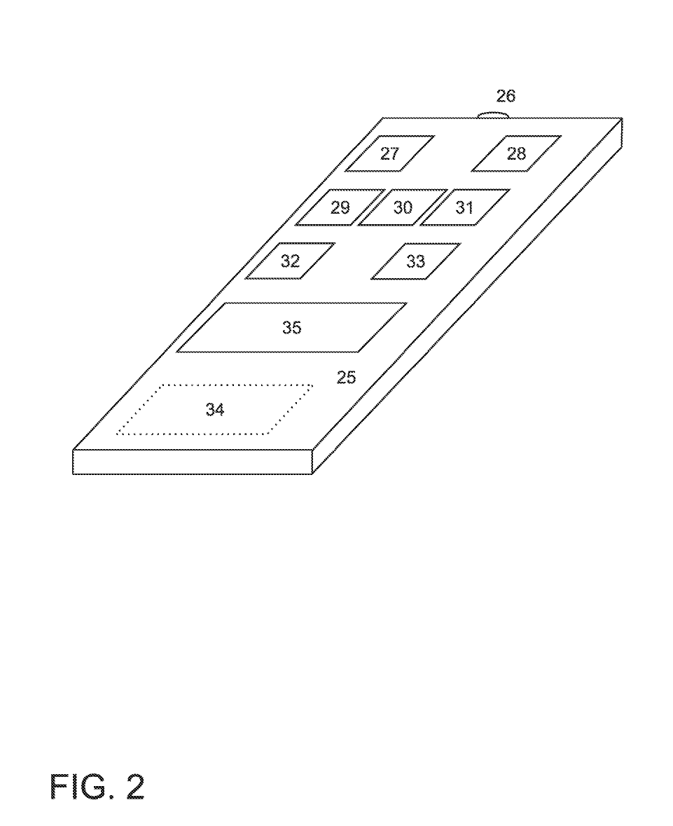

FIG. 2 is a perspective view of a remote control device of another embodiment of the invention.

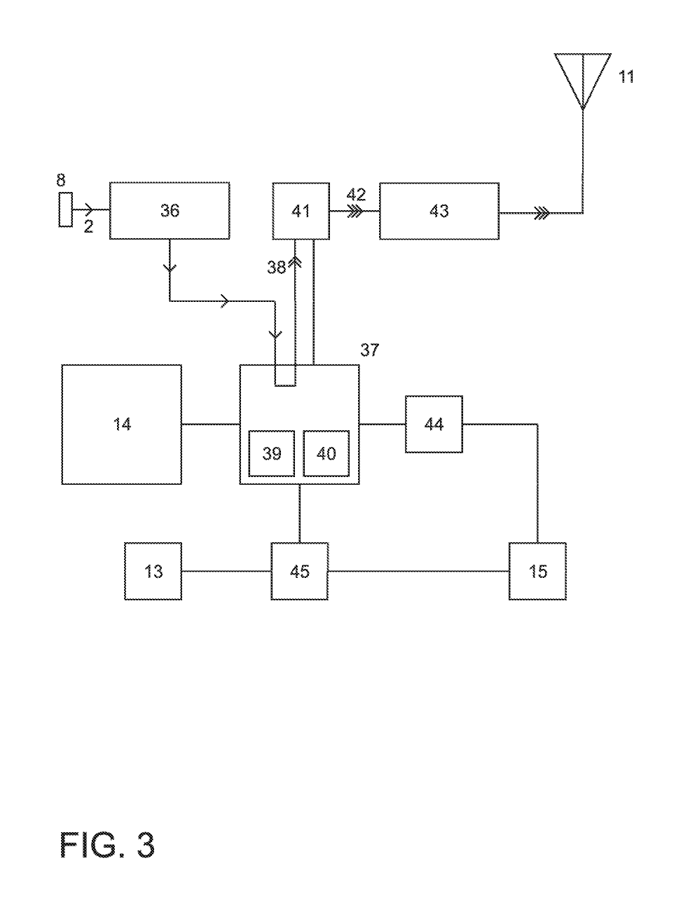

FIG. 3 is a schematic diagram in block form of the functional components that comprise the monoaural transmitter device of another embodiment of the invention.

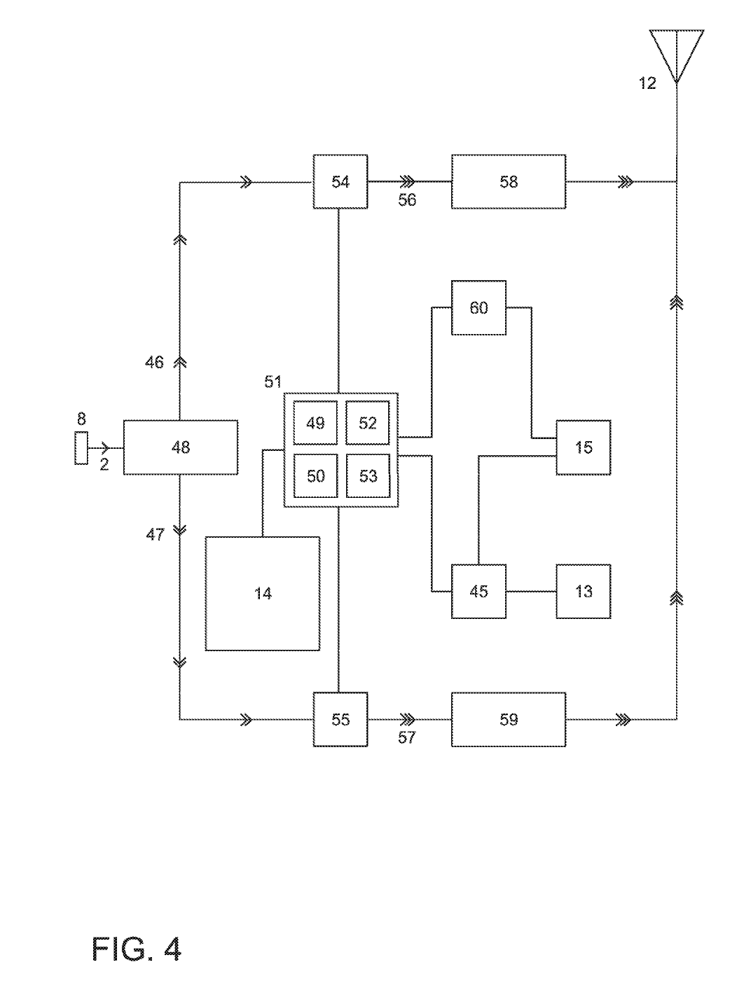

FIG. 4 is a schematic diagram in block form of the functional components that comprise the stereo transmitter device of another embodiment of the invention.

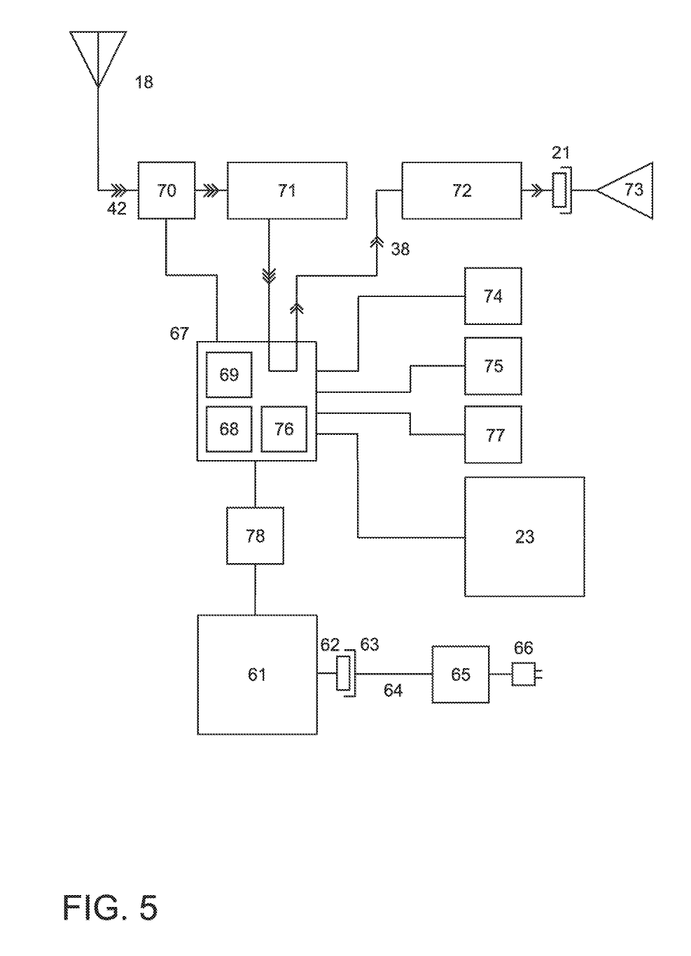

FIG. 5 is a schematic diagram in block form of the functional components that comprise the monoaural broadcast receiver device of another embodiment of the invention.

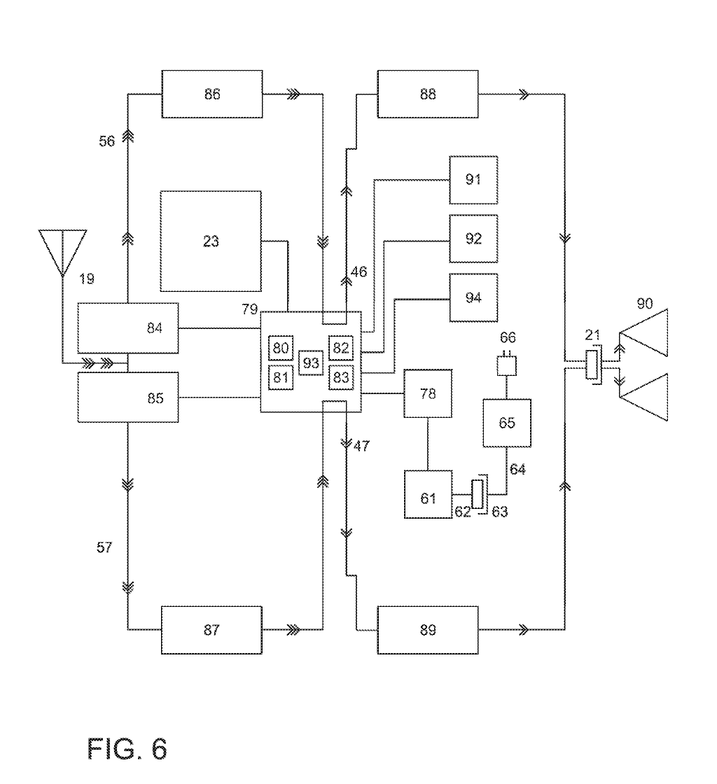

FIG. 6 is a schematic diagram in block form of the functional components that comprise the stereo broadcast receiver device of another embodiment of the invention.

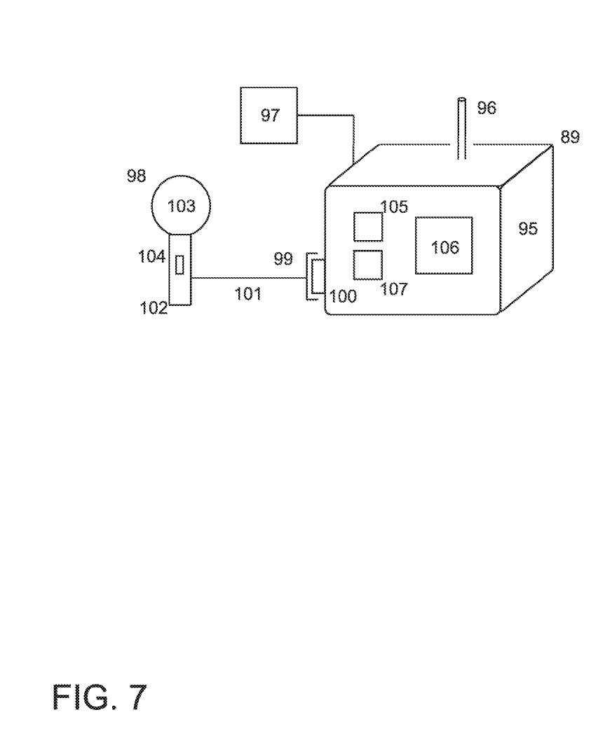

FIG. 7 is a perspective view of the override transmitter auxiliary device of another embodiment of the invention.

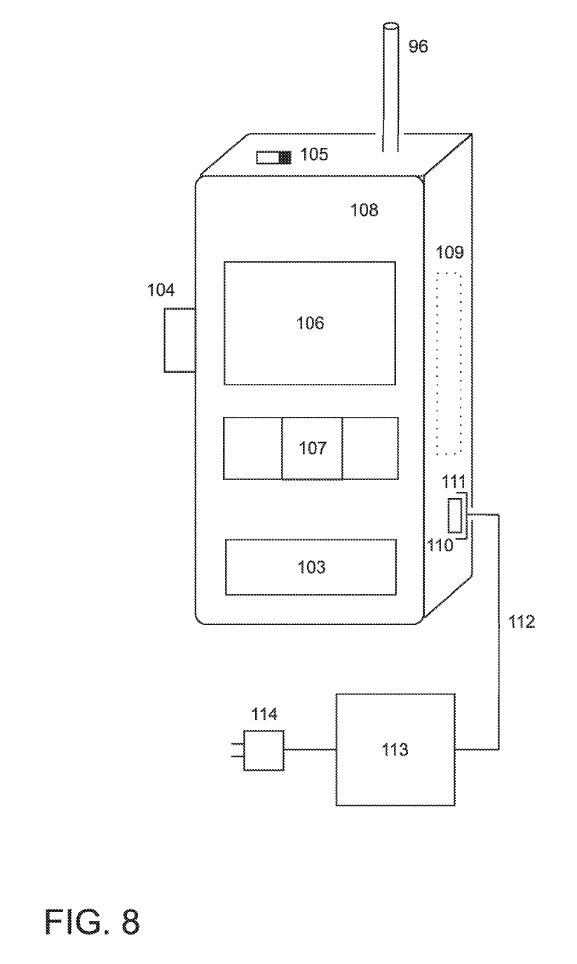

FIG. 8 is an alternate perspective view of the override transmitter auxiliary device of another embodiment of the invention.

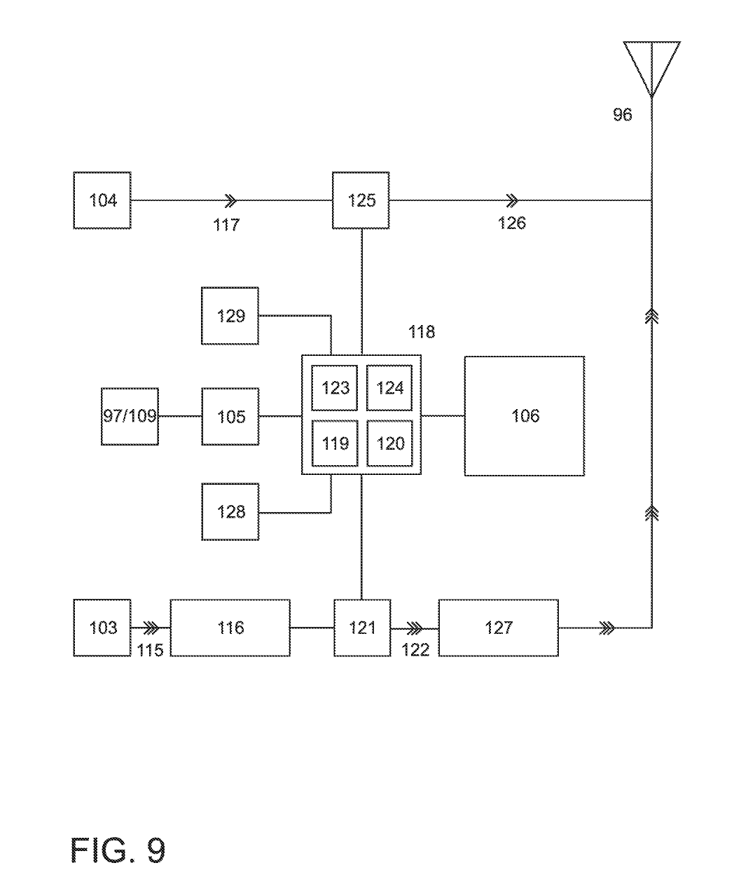

FIG. 9 is a schematic view in block form of the functional components that comprise the override transmitter auxiliary device of another embodiment of the invention.

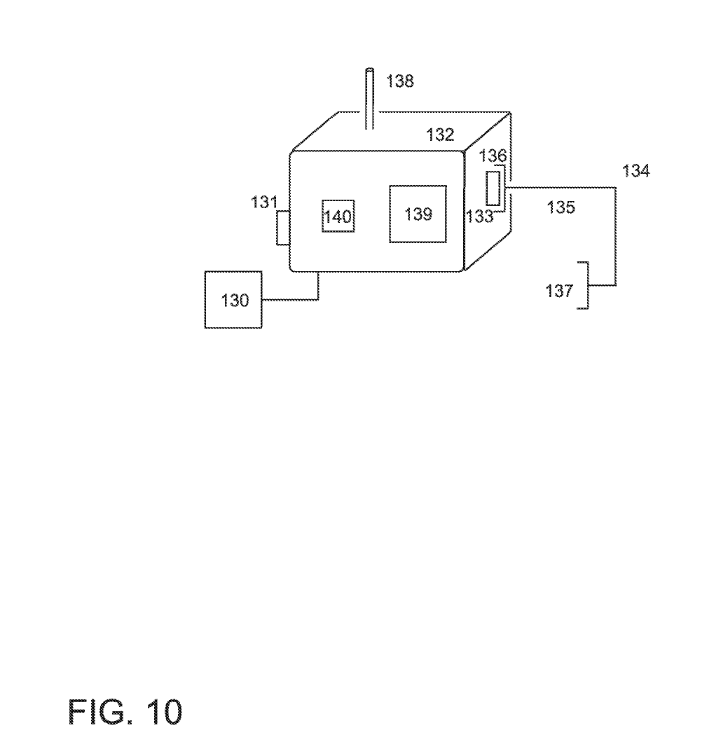

FIG. 10 is a perspective view of the override broadcast receiver add-on auxiliary device of another embodiment of the invention.

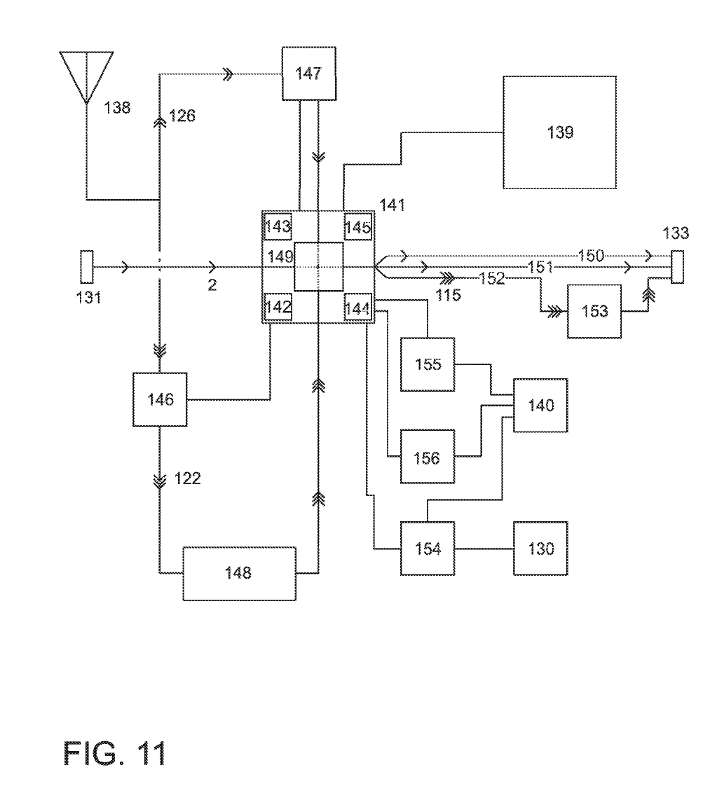

FIG. 11 is a schematic view in block form of the functional components that comprise the override broadcast receiver add-on auxiliary device of another embodiment of the invention.

### DETAILED DESCRIPTION

### Figures of the First Embodiment

FIG. 1 shows a perspective view of the preferred embodiment. An audio input device [1] such as a T.V. set, cable, satellite or receiver box generates an audio input signal [2] shown with a pathway denoted by a directional arrow, that propagates through an output port [3] into and an audio transfer linkage [4]. Said linkage consists of a universal audio connector plug [5] at the audio input device terminus, a cord [6] and a second audio connector plug [7]. The universal audio plug [5] is compatible with the output port [3] integrated with said audio input device and can include the plurality of a SCART, RCA, headphone, 3.5 mm, optical or a HDMI connector. Said second audio connector plug, not necessarily of the same type, is compatible with an input port [8] integrated with a housing [9] of a transmitter device [10]. Through said linkage said audio input signal can be propagated in monoaural or stereo format. I currently conceive that the audio transfer linkage be utilized, however a hardwired or direct interconnection between said audio input device and said transmitter device could also be exploited. Said cord, port and plug connectors contain pins or wires of number, type and designation as dictated by well known processes and technology. Said linkage is shielded and insulated as necessary to prevent signal loss and external interference. The transmitter device modulates said audio input signal [2] to a radio wave carrier frequency compliant with a set programmed channel description and broadcasts through a transmitting antenna [11/12]. A means for electrification [13] is achieved according to well known processes and technology. A display [14] and an infrared window [15] are also integrated with the housing. A self contained broadcast receiver device [16] enclosed within a housing [17] senses the broadcasted channel from said transmitter device via a receiving antenna [18/19], processes said channel and outputs an audio signal to an aural listening device [20] associated via a means for interconnection [21]. A hook, clip or another attachment implement [22] is integrated with the housing and provides a means for anchorage, although this implement is not necessary for device operation. A display [23] and a user controlled means for modifying the device's settings [24] are also integrated.

FIG. 2 shows a perspective view of the remote control device. When installed some of the components are generally inaccessible, which necessitates a means for remote interaction. A housing [25] encloses the device and to which an infrared light emitting diode [26] is integrated. Associated functions include, but are not necessarily required nor limited to: a power switch [27] and a channel switching function [28] associated to said transmitter device; a power switch [29] and channel switching functions [30,31] associated to an override broadcast receiver add-on auxiliary device described in FIG. 10 and FIG. 11; a control switching function for the transmitter device [32] and a control switching function for the override broadcast receiver add-on auxiliary device [33]. Said control switching functions modify a set programmed code that allows said remote control to preferentially interact with said device or auxiliary device. Non-inclusion of the override broadcast receiver add-on auxiliary device allows for exclusion said associated functions. A battery power pack [34] provides a means for electrification according to well known processes and technology. I presently believe that a display [35] be integrated into said housing such that said channels can be primarily defined with the remote control device then input via intercommunication with said device or auxiliary device, however said display is not necessary.

FIG. 3 shows a schematic diagram in block form of the operational components that comprise the monoaural transmitter device. The audio input port [8], compatible with said audio connector plug of said audio transfer linkage, allows for propagation of the audio input signal [2] along a pathway denoted by a directional arrow. If it is deemed advantageous, that said linkage can be hardwired at the transmitter terminus and thereby said audio connector plug and audio input port can be excluded. An amplifier [36] provides a means for optimization of said audio input signal. A microprocessor [37] modulates said audio input signal, if propagated in stereo format, to provide a monoaural audio signal [38], shown with a pathway denoted by double directional arrows. A channel changer function [39] integrated with said microprocessor allows for selection of a set programmed channel description. Said channel can be of a frequency, amplitude or digital modulated radio wave carrier frequency that conforms to the required standards set forth and governed by local laws and regulations to carry an audio signal consistent with the device described herein. If required an encryption algorithm can be imposed on the channel by well known processes and technology. I currently believe that a higher frequency band be utilized in the GHz range which allows for the option of spreading said channel over a wider bandwidth than required for narrowband simple point-to-point communication which increases the signal to noise ratio, displays less susceptibility to inference and allows for a better broadcast range to be realized. Utilization of the preferred or narrowband format can lead to a classification of many set programmed channel descriptions, of which a distinct selection are assessable to said channel changer function. A microprocessor integrated frequency mixing function 1401 induces conformation of a frequency oscillator [41], of the voltage controlled type, to perform direct frequency modulation of said monoaural audio signal to a channel containing the monoaural audio signal [42], shown with a pathway denoted by triple directional arrows. Optimization of said channel is achieved by utilization of an amplifier [43]. Radiation of said channel containing the monoaural audio signal is performed through said transmitting antenna [11]. Device installation with respect to antenna size, helical whip, gain and installation environment can be optimized according to the well known transmission-reception properties of radio waves. A means for electrification [13] is achieved by well known processes and technology. A display [14] is integrated with said microprocessor. Remote interactions can occur via an interaction with said remote control through an integrated infrared window [15], however if physical interfacing is required said infrared window can be replaced or said device be augmented with a user controlled means for modifying the device's settings. Said set programmed channel description entered into said channel changer is modified by a channel switching function [44] and said electrification is dictated by a power switch [45].

FIG. 4 shows a schematic diagram in block form of the operational components that comprise the stereo transmitter device. Much is repeated for clarity from that included as part of the FIG. 3 detailed description. The addition, duplication or substitution of functional components as required for stereo format compliancy allows for a left [46] and a right [47] audio input signal to be individually treated. The audio input port [8], compatible with said audio plug of said audio transfer linkage, allows for propagation of the audio input signal [2] in stereo format, along a pathway represented by a directional arrow. If it is deemed advantageous, that said linkage can be hardwired at the transmitter terminus and thereby said audio input port and audio plug can be excluded. A stereo amplifier and splitter [48] combination provides a means for optimization and splitting of the left [46] and right [47] audio signal components along distinct pathways, both shown by double directional arrows. Two channel changer functions [49,50] are integrated within a microprocessor [51] that provide a means for selection of interrelated set programmed channel descriptions. Said channels can be of a frequency, amplitude or digital modulated radio wave carrier frequency that conform to the required standards set forth and governed by local laws and regulations to carry audio signals consistent with the device described herein. If required an encryption algorithm can be imposed on the interrelated channels by well known processes and technology. I currently believe that a higher frequency band be utilized in the GHz range which allows for the option of spreading said channels over a wider bandwidth than required for narrowband simple point-to-point communication which increases the signal to noise ratio, displays less susceptibility to inference and allows for a better broadcast range to be realized. Utilization of either the preferred or narrowband format can lead to a classification of many set programmed channel descriptions, of which a distinct interrelated selection are assessable to said channel changer functions. Two microprocessor integrated frequency mixing functions [52,53] induce conformation of separate frequency oscillators [54,55] to perform direct frequency modulation of said left and right audio signals into separate, interrelated channels containing the left [56] and right [57] audio signal, both shown with pathways denoted by triple directional arrows. Said frequency oscillators are of the voltage controlled type. Signal optimization of said channels is achieved by utilization of amplifier and filter [58,59] combinations. Said channels are concurrently radiated through the transmitting antenna [12]. Device installation with respect to antenna size, helical whip, gain and installation environment can be optimized according to the well known transmission-reception properties of radio waves. A means for electrification [13] is achieved by well known processes and technology. A display [14] is associated with said microprocessor. Remote interactions can occur via an interaction with said remote control through an integrated infrared window [15], however if physical interfacing is required said infrared window can be replaced or said device be augmented with a user controlled means for modifying the device's settings. Said interrelated set programmed channel descriptions entered into said channel changer functions are modified concurrently by a single channel switching function [60] and said electrification is dictated by a power switch [45].

FIG. 5 shows a schematic diagram in block form of the operational components that comprise the monoaural broadcast receiver device. A means for electrification [61] is achieved with a fixed rechargeable or conventional battery pack. The preferred rechargeable option requires a means for recharging, which is provided by a combination of an integrated port [62], a compatible plug [63], a cord [64] a transformer [65] and a power plug [66] which can be connected to the mains. A microprocessor [67] contains an integrated channel changer function [68] and a frequency mixing function [69] which induce a closely related conformation of an associated frequency resonator [70] to said set programmed channel description being broadcasted. A receiving antenna [18] senses said channel containing the monoaural audio signal [42] shown with a pathway denoted by triple directional arrows. An amplifier [71] provides a means for optimization of said channel. Said channel is processed to again provide the monoaural audio signal [38], shown with a pathway denoted by double directional arrows. An amplifier [72] provides a means for optimization of said processed signal. Output of said monoaural audio signal is performed to a monoaural aural listening device [73] that consists of a small speaker and a means for interconnection [21], which comprises either a plug and port or a hardwired interaction. A volume control function [74] has been integrated with said microprocessor and acts to adjust the perceived sound level at said small speaker by well known processes and technology. Said volume control function may be situated differently, for example directly integrated with said amplifier [72] or be externally integrated with the aural listening device. A display [23] is associated with said microprocessor. The preferred integration of a searching function or an interfacing device [75] provides a means by which said broadcasted set programmed channel descriptions are input or classified and stored in a channel memory function [76]. Said interfacing device provides a means for interaction and can include an infrared sensor or a plug and port connection. A mirrored insertion of the distinct selection of available channels from that input into said monoaural transmitter device's channel changer function can also be input into said channel changer function [68] and thereby the above preferred integrated components can be eliminated. Other device integrated functions include a channel switching function [77], not necessarily integrated with said channel changer memory function and a power switch [78] that controls electrification. In the event that broadcast arises from said stereo transmitter device, said monoaural broadcast receiver device can sense, process and output one of either said channels containing the left or right audio signal.

FIG. 6 shows a schematic diagram in block form of the operational components that comprise the stereo broadcast receiver device. Much is repeated for clarity from that provided in the detailed description of FIG. 5. The addition, substitution or duplication of functional components as required for stereo format compliancy allows for the channels containing the left [56] and right [57] audio signals to be individually treated in the same manner as that of the channel containing the monoaural audio signal. A means for electrification [61] is achieved with a fixed rechargeable or conventional battery pack. The preferred rechargeable option requires a means for recharging, which is provided by a combination of an integrated port [62], a compatible plug [63], a cord [64] a transformer [65] and a power plug [66] which can be connected to the mains. Integrated with a microprocessor [79] are two channel changer functions [80,81] and two frequency mixing functions [82,83] which induce the independent closely related conformation of two associated frequency resonators [84,85] to said interrelated set channel descriptions being broadcasted. Said channels containing the left [56] and right [57] audio signals are concurrently sensed through a receiving antenna [19]. An amplifier [86,87] for each channel provides a means for optimization, with divergent pathways both shown by triple directional arrows. Said microprocessor processes the channels to again provide the left [46] and right [47] audio signals shown with pathways both denoted by double directional arrows. Amplifiers [88,89] provide a means for optimization of said processed signals. Output of said audio signals is performed to a stereo aural listening device [90] that consists of left and right small speakers and a means for interconnection [21], either being a plug and port or a hardwired interaction. A volume control function [91] has been integrated with said microprocessor and acts to adjust the perceived sound level delivered to each of said small speakers in accordance with well known processes and technology. Said volume control function may be situated differently, for example directly integrated with said amplifiers [88,89] or be externally integrated with the aural listening device. A display [23] is associated with said microprocessor. The preferred integration of a searching function or an interfacing device [92] provides a means by which said broadcasted interrelated left and right set programmed channel descriptions are input or classified and stored in a channel memory function [93]. Said interfacing device provides a means for interaction and can include an infrared sensor or a plug and port connection. A mirrored insertion of the distinct selection of available interrelated channels from that input into said transmitter device's channel changer functions can also be input into said stereo channel changer functions [80,81] and thereby the above preferred integrated components can be eliminated. Other device integrated functions include a channel switching function [94], that switches concurrently in between said interrelated left and right set programmed channel descriptions which is not necessarily integrated with said channel changer memory function and a power switch [78] that controls electrification. In the event that broadcast arises from said monoaural transmitter device, said stereo broadcast receiver device can sense, process and output the monoaural signal along one of either the left or right pathways or concurrently along both.

FIG. 7 shows a perspective view of the override transmitter auxiliary device. A housing [95] encloses the device and supports a transmitting antenna [96]. A means for electrification is achieved by well known processes and technology [97]. An external microphone device [98] is connected through a plug [99] and port [100] combination via a cord [101] and comprises a housing [102], a microphone [103] and an activate transmission switch [104]. I currently conceive that the microphone should be directly corded or hardwired, however substitution of a wireless microphone is possible. A power switch [105], a display [106] and a user controlled means for modifying the settings [107] are integrated with the device.

FIG. 8 is an alternate perspective view of the override transmitter auxiliary device with a hand held format. Many of the components from the FIG. 7 description are repeated for clarity. This alternate device format has the advantage of greater mobility and simplicity. Said device is enclosed within a housing [108]. A transmitting antenna [96] is mounted onto said housing. A means for electrification [109] is achieved with a fixed rechargeable or conventional battery pack. The preferred rechargeable option requires a means for recharging, which is provided by a combination of an integrated port [110], a compatible plug [111], a cord [112] a transformer [113] and a power plug [114] which can be connected to the mains. A microphone [103] and an activate transmission switch [104] are integrated. A power switch [105], a display [106] and a user controlled means for modifying the settings [107] are also integrated with the device.

FIG. 9 shows a schematic view of the operational components that comprise the override transmitter auxiliary device. A means for electrification [97/109] is achieved according to well known processes and technology. The microphone [103] is utilized to generate a vocal audio signal [115] in response to stimuli and is shown with a pathway denoted by triple directional arrows. An amplifier [116] provides a means for optimization. The activate transmission switch [104] generates an activation signal [117] with an acceptable format as required for modulation and broadcast and is shown with a pathway denoted by double directional arrows. Integrated with a microprocessor [118] is a channel changer function [119] and a frequency mixing function [120] that induce a frequency oscillator [121] to modulate said vocal audio signal [115] to a channel containing the vocal audio signal [122] also shown with a pathway denoted by triple directional arrows. Another microprocessor integrated channel changer function [123] and a second frequency mixing function [124] induce a second frequency oscillator [125] to modulate said activation signal to a channel containing the activation signal [126] also shown with a pathway denoted by double directional arrows. Said channels can be of a frequency, amplitude or digital modulated radio wave carrier frequency that conform to the required standards set forth and governed by local laws and regulations to carry audio signals consistent with the device described herein. If required an encryption algorithm can be imposed on the channels by well known processes and technology. I currently believe that a higher frequency band be utilized in the GHz range which allows for the option of spreading said channel over a wider bandwidth than required for narrowband simple point-to-point communication which increases the signal to noise ratio, displays less susceptibility to inference and allows for a better broadcast range to be realized. Utilization of either the preferred or narrowband format can lead to a classification of many set programmed channel descriptions, of which a distinct selection are assessable to said channel changer functions. An amplifier and filter [127] combination provides a means for optimization of said channel containing the vocal audio signal by well known processes and technology. Through utilization of a transmitting antenna [96] capable of concurrently radiating multiple channels, said channels containing the vocal audio and activation signals are radiated. A display [106], two independent channel switching functions [128,129], one for each channel changer function and a power switch 11051 that controls said electrification also are integrated. Described above is an example of a single layer authentication setup with broadcast of a single activation signal, however multiple activation signals can be induced concurrently by said activate transmission switch and broadcasted over distinct channels allowing for a multilayered authentication to be realized. In this event organization and multiplication of the associated functional components allows for this possibility.

FIG. 10 shows a perspective view of the override broadcast receiver add-on auxiliary device. A means for electrification [130] is achieved by well known processes and technology. A compatible input port [131] with the transmitter terminus plug of the audio transfer linkage, detailed in FIG. 1, is integrated with a housing [132]. An output port [133] is also integrated with said housing. An auxiliary audio transfer linkage [134] that consists of a cord [135] with plugs [136,137] at each terminus allows for audio signal propagation. Said auxiliary linkage is not required if a port and plug interconnection or direct hardwiring associates the transmitter device. A receiving antenna [138] capable of concurrently sensing multiple broadcasted channels, a display [139] and an infrared window [140] are also integrated with said housing.

FIG. 11 shows a schematic view in block form of the operational components that comprise the override broadcast receiver add-on auxiliary device. A means for electrification [130] is achieved by well known processes and technology. Said audio input signal [2] with a pathway denoted by a single directional arrow, enters the device through said input port [131]. Integrated into a microprocessor [141] are two channel changer functions [142,143] and two frequency mixing functions [144,145] each being independently associated with a frequency resonator [146,147]. This arrangement allows for concurrent independent reception via said receiving antenna [138] of frequencies closely related to said set programmed channel descriptions being broadcasted from the override transmitter auxiliary device described in FIG. 5, FIG. 6 and FIG. 7. An amplifier [148] provides a means for optimization of said channel containing the vocal audio signal [122] shown with a pathway denoted by triple directional arrows. According to well known processes and technology said microprocessor contains a gating function [149] that can preferentially throughput a gated audio signal along one of three pathways, denoted as [150], [151], and [152]. Pathway [150] is given priority in the absence of a sensed broadcasted channel from said override transmitter auxiliary device, wherein said audio input signal is propagated and denoted by a directional arrow. Reception of the broadcasted channel containing the activation signal [126] shown with a pathway denoted by double directional arrows, induces a gating from pathway [150] to [151] with the continued propagation of the audio input signal, again denoted by a directional arrow. The concurrent reception of the two channels containing the vocal audio signal [122] and the activation signal [126] also induces gating, wherein interruption of the audio input signal with processing and propagation of the channel containing the vocal audio signal results along pathway [152] as the vocal audio signal [115], again shown by triple directional arrows. An amplifier [153] provides a means for optimization of said processed vocal audio signal according to well known processes and technology. Independent of pathway, the gated signal propagates through said output port [133]. A display [139], an infrared window [140], a power switch [154] that controls electrification and two channel switching functions [155,156] are also integrated. If physical setting manipulation is required said infrared window can be replaced or said device be augmented with a user controlled means for modifying the device's settings. Deactivation of said electrification necessitates maintenance of pathway [150]. Described above is an example of a single layer authentication setup with reception of the activation signal being necessary to induce gating, however a multilayered authentication process can be realized by necessitating the concurrent reception of multiple distinct activation signals. In this event organization and multiplication of the associated functional components allows for this possibility.

### CONCLUSION, RAMIFICATIONS AND SCOPE

It is evident that, according to one embodiment of the invention, I have provided a means by which the combination of devices described allows for the audio signal rebroadcasting from a T.V. set via a transmitter device to a broadcast receiver device pathway. Through augmentation with auxiliary devices an overriding vocal signal can be broadcasted globally via the same pathway. The limitations endured by the prior art are overcome including connectivity, range of broadcast, susceptibility to interference, and broadcast reception security while conforming to the restrictions imposed by local laws and regulations. The above description contains many specificities, these however should not be construed as limitations on the scope of any embodiment, but as exemplifications of the presently preferred embodiments thereof. Many other ramifications and variations are possible within the teaching of the various embodiments. Thus the scope of the invention should be determined by the appended claims and their legal equivalents and not by the examples given.

1. A self contained apparatus comprising:
an audio transfer linkage that provides a means for propagation of an audio input signal from an audio input device, typically a T.V. set at a first location to a transmitter device;
said transmitter device modulates said input audio signal and broadcasts over the airwaves along a switchable radio wave frequency that conforms with a set programmed channel description;
a broadcast receiver device tuned appropriately to said set programmed channel description and within range of said broadcast, senses, processes and outputs the channel at a second location remotely located from said first location.

2. The system of claim 1 wherein said audio input device is typically a T.V. set as selected from the group that comprises a T.V. set, cable, satellite and receiver box.

3. The apparatus of claim 1 wherein said audio transfer linkage comprises:
a terminal plug at each end that is compatible and can be associated with either of said audio input device or said transmitter device;
an interconnecting cord joins said plugs and each contain pins or wires, through which said audio input signal is propagated;
said audio input signal can exhibit the monoaural or stereo format;
said plugs are not necessarily of the same and can include the plurality of a SCART, RCA, headphone, 3.5 mm, optical or HDMI type;
whereby through said audio transfer linkage said audio input signal is propagated.

4. The apparatus of claim 1 wherein said transmitter device that broadcasts in monoaural format comprises:
a housing;
a display;
an input port, compatible with the transmitter terminus plug of said audio transfer linkage;
said audio input signal enters said device where an amplifier provides a means for optimization;
an electrified microprocessor modulates said audio input signal to provide a monoaural audio signal if in stereo format;
contained within a channel changer function are said set programmed channel descriptions, which consist of a radio wave frequency, characteristic of a narrowband or wide bandwidth;
said channel changer function and a frequency mixing function constitute a means for inducing an associated frequency oscillator to conform with said set programmed channel description;
said frequency oscillator modulates said monoaural audio signal to a channel containing the monoaural audio signal;
a means for optimization of said channel containing the monoaural audio signal is achieved by utilization of an amplifier;
by means of a transmitting antenna said channel containing the monoaural audio signal is radiated over the airwaves;
whereby said audio input signal is modulated to said channel containing the monoaural audio signal and is broadcasted.

5. The apparatus of claim 4 wherein said microprocessor has functions or associated processes that constitute:
a means for modulation of said audio input signal to exhibit monoaural character if propagated through said audio transfer linkage in stereo format;
a remote channel switching function provides a means for selecting said set programmed channel description expressed by said channel changer function;
said remote function comprises an interaction of a remote control device via an integrated infrared window;
a means for modifying said frequency mixing function to direct said frequency oscillator to match said set programmed channel description as dictated by said channel changer function;
a means for dictating the power level of said amplifiers such that optimization is achieved;
a means for transferring relevant information to said display;
a means for electrifying;
a remote switchable means for controlling the electrification;
whereby through implementation of said microprocessor functions and associated processes according to well known processes and technology said transmitter device is rendered operational.

6. The apparatus of claim 4 wherein said transmitter device that broadcasts in monoaural format can be differently assembled to broadcast in stereo format by duplicating, substituting, adding or eliminating specific functional components comprising:
a duplication of said channel changer function;
a duplication of said mixing function;
a duplication of said frequency oscillator;
an addition of an integrated splitter and amplifier combination that treats the audio input signal;
a substitution of two amplifier and filter combinations that provide a means for channel optimization;
an elimination of said microprocessor function that modulates said audio input signal to exhibit monoaural format;
a substitution of a single remote channel switching function to simultaneously select and input interrelated programmed channel descriptions for the left and right audio input signals into said channel changer functions;
whereby a stereo transmitter device can modulate each of the left and right audio input signals to broadcast in stereo format.

7. An apparatus of claim 1 wherein said broadcast receiver device that receives in monaural format comprises:
a housing;
a display;
an electrified microprocessor;
an integrated hook, clip or another attachment device that provides a means for anchorage;
a combination of a channel changer function and a frequency mixing function integrated into said microprocessor that provides a means to induce an associated frequency resonator to conform closely to said broadcasted set programmed channel description;
a receiving antenna provides a means for sensing said broadcasted channel containing the monoaural audio signal;
an amplifier provides a means for optimization of said channel;
said channel containing the monoaural audio signal propagates into said microprocessor where processing occurs to again provide said monoaural audio signal;
an amplifier provides a means for optimization of said processed monoaural audio signal;
a means for connection of an aural listening device;
whereby said monoaural audio signal is remotely sensed, processed and output to said aural listening device.

8. The apparatus of claim 7 wherein said microprocessor contains functions or associated processes that constitute:
a channel switching function that provides a means for modifying the set programmed channel description expressed by said channel changer function;
a means for modifying the settings expressed by said frequency mixing function to direct said frequency resonator to conform closely to said set programmed channel description as dictated by said channel changer;
a means for dictating the power level of said amplifiers such that optimization is achieved;
a means to input the set programmed channel descriptions into a memory function;
a means for electrifying;
a switchable means for controlling said electrification;
a variable means for controlling the volume sensed at the aural listening device;
a means for transferring relevant information to a display;
whereby through implementation of said microprocessor functions and associated processes according to well known processes and technology said broadcast receiver device is rendered operational.

9. The apparatus of claim 7 wherein said broadcast receiver device that receives in monoaural format can be differently assembled to sense the stereo broadcast format by substitution and duplication of specific functional components comprising:
a substitution of a multi-speaker aural listening device;
a substitution of a receiving antenna that is capable of concurrently sensing both broadcasted channels containing the left and right audio signals
a substitution of said amplifier that optimizes said channel with an amplifier and splitter combination that provides a means for optimization and separation of said channels containing the left and right audio signals along separate signal pathways;
a duplication of said channel changer function;
a substitution of a channel switching function that switches in between said interrelated channels;
a duplication of said frequency resonator;
a duplication of said mixing function;
a duplication of said amplifier to optimize said processed audio signals;
thereby a stereo broadcast receiver device can simultaneously sense, process and output the interrelated broadcasted channels containing the left and right audio signals.

10. A self contained apparatus comprising:
an override transmitter auxiliary device that provides a means for broadcasting two distinct channels containing a vocal audio signal and an activation signal concurrently over two set programmed channel descriptions;
and an override broadcast receiver add-on auxiliary device that interrupts said audio transfer linkage, can be tuned to, sense, gate and processes said broadcasted channels such that propagation through an auxiliary audio transfer linkage of either said audio input signal or a processed vocal audio signal into said transmitter device is achieved when within range of said broadcast.

11. The apparatus of claim 10 wherein said override transmitter auxiliary device comprises:
a housing;
a display;
an electrified microprocessor;
an activate transmission switch that provides a means for generation of said activation signal with appropriate characteristics;
a microphone provides a means for generation of said vocal audio signal in response to sensed stimuli according to well known processes and technology;
a linkage that consists of a cord and terminal plugs or direct hardwiring which associates said microphone and said activate transmission switch and comprises wires of number and type as consistent with propagation of said vocal audio and activation signals;
an amplifier provides a means for optimization of said vocal audio signal;
two channel changer functions and two frequency mixing functions are integrated with said microprocessor and constitute a means for inducing two independent frequency oscillators to modulate said vocal audio and activation signals to conform with distinct set programmed channel descriptions;
an amplifier and filter combination provides a means for optimization of said channel containing the vocal audio signal;
a transmitting antenna provides a means for radiation of said channels containing the vocal audio signal and the activation signal simultaneously over the airwaves;
whereby channels containing the vocal audio and the activation signals are broadcasted.

12. The apparatus of claim 11 wherein said microprocessor has functions or associated processes that constitute:
two channel switching that functions provide a means for selecting and entering said set programmed channel descriptions into said channel changer functions;
a means for modifying the settings of said mixing functions;
a means for modifying said frequency mixing functions to direct said frequency oscillators to match said set programmed channel descriptions as dictated by said channel changer functions;
a means for dictating the power level of said amplifiers such that optimization is achieved;
a means for electrifying;
a switchable means for controlling said electrification;
a means for transferring relevant information to said display;
whereby through implementation of said microprocessor functions and associated processes according to well known processes and technology said override transmitter auxiliary device is rendered operational.

13. The apparatus of claim 10 wherein said override broadcast receiver add-on auxiliary device comprises:
a housing;
a display;
said audio input signal of claim 1 propagates through an input port compatible with said transmitter terminus plug described in claim 3;
an electrified microprocessor;
a microprocessor integrated audio signal gating function;
a combination of two channel changer functions and two frequency mixing functions integrated with said microprocessor that induce two independent associated frequency resonators to conform closely with said set programmed channel descriptions;
a receiving antenna concurrently senses said channels containing the vocal audio and activation signals;
an amplifier and splitter combination provides a means for optimization of said channel containing the vocal audio signal and separation of said channels along separate pathways;
said microprocessor processes said channel containing the vocal audio signal;
an amplifier provides a means for optimization of the processed vocal audio signal;
said microprocessor imposes said gating function to preferentially propagate said audio input signal or said vocal audio signal through an output port;
said vocal audio signal can be propagated through said output port in monoaural in a bi-channel format with an identical audio signal being propagated along both left and right signal pathways;
an auxiliary audio transfer linkage bridges in between said override broadcast receiver add-on auxiliary device and said transmitter device of claim 1;
whereby a gated audio signal that corresponding to either the audio input signal or the vocal audio signal is propagated into said transmitter device.

14. The apparatus of claim 13 wherein said microprocessor integrated gating function comprises:
a means for selective audio signal propagation which is achieved by integration of a gating switch according to well known processes and technology;
said gating switch can interrupt said audio input signal when a positive gating condition is satisfied by the concurrent reception of said channels containing the vocal audio and the activation signals.
reception is accepted of either said vocal audio or activation signal when sensed with or without the counterpart being present.

15. The apparatus of claim 13 wherein said microprocessor contains functions or associated processes comprising:
said gating function described in claim 14;
two remote controlled channel switching functions provide a means for the independent selection and input of said two set programmed channel descriptions into said channel changer functions;
said remote functions comprise an interaction in between the remote control device through an integrated infrared window;
a means for modifying the settings expressed by said frequency mixing function to direct said frequency resonators to conform closely with said set programmed channel descriptions as dictated by said channel changer functions;
a means for dictating the power level of said amplifiers such that optimization is achieved;
a means for electrifying;
a remote switchable means for controlling said electrification;
a means for transferring relevant information to a display;
whereby through implementation of said microprocessor functions and associated processes according to well known processes and technology said override broadcast receiver add-on auxiliary device is rendered operational.

16. The apparatus of claim 10 wherein said auxiliary audio transfer linkage comprises:
a length of cord terminated by plugs;
said cord and plugs contains wires or pins, respectively that allow for said audio input signal or vocal audio signal to be propagated;
said plugs terminating said cord are compatible with the integrated output port of the auxiliary device or said input port of the transmitter device;
whereby said gated signal can propagate in between said override broadcast receiver add-on auxiliary device and the transmitter device.
